(19) United States
(12) Patent Application Publication
(10) Pub. No.: US 2010/0100779 A1
(43) Pub. Date: Apr. 22, 2010

(54) Data processing apparatus

(75) Inventor: Takaaki Moriya, Kanagawa (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC Electronics Corporation, Kawasaki (JP)

(21) Appl. No.: 12/588,218

(22) Filed: Oct. 7, 2009

(30) Foreign Application Priority Data
Oct. 8, 2008 (JP) 2008-262240

(51) Int. Cl. G06F 11/07

(52) U.S. Cl. 714/718; 714/E11.021

(57) ABSTRACT

A data processing apparatus includes a memory, an error detection circuit, a timing adjustment circuit and a terminal. The error detection circuit detects an error based on an output of the memory to output an error detection signal. The timing adjustment circuit enlarges a pulse width of a pulse signal which is generated at first after a start of a predetermined operation among pulse signals included in the error detection signal. The terminal outputs an output of the timing adjustment circuit when a test for the memory is performed. It is possible to report an occurrence of an error reliably without increasing the number of output terminals, test patterns or test time.

### INCORPORATION BY REFERENCE

This application is related to Japanese Patent Application No. 2008-262240 filed at 8 Oct. 2008. The disclosure of that application is incorporated herein by reference.

### BACKGROUND OF THE INVENTION

1. Field of the Invention

The present invention relates to a data processing apparatus and more specifically to a data processing apparatus having a built-in memory with an error detection function.

2. Description of Related Art

A data processing apparatus such as a microcomputer or the like includes a memory storing programs, data and so on. Such a data processing apparatus includes an error detection circuit and an error correction circuit, and monitors memory malfunction. Moreover, through an operation test of the memory, the error detection circuit, and the error correction circuit, normality is checked and a faulty section is identified. For example, Japanese Laid-Open Patent Application JP-A-Heisei, 11-273396 indicates an example of an error detection circuit and an error correction circuit used in a semiconductor memory device and being capable of one bit error correction.

Inspections of a data processing apparatus are mainly classified into a shipping inspection and a fault inspection. At the shipping inspection, it is inspected whether or not performance and functions of the data processing apparatus meet given standards. That is, a test pattern is inputted, and it is inspected that an expected value corresponding to the test pattern is outputted. Therefore, in a case of the test of the error detection circuit and the error correction circuit of the memory, timing at which an error detection signal is outputted is previously assumed. In a case where no expected value is obtained at the assumed timing, the testing device determines that the data processing apparatus is in failure.

On the other hand, in a case of the fault inspection, a faulty condition is represented to detect a faulty section and information for finding out a cause of the fault is collected. Therefore, it is required to detect an output of a value which is not able to be expected from a predetermined input test pattern. In a case of a test of the error detection and correction circuit of a memory, the timing at which an error detection signal is outputted is irregular and thus cannot be predicted. In particular, in a case where an error is detected while a program is executed, the timing of error detection cannot be predicted. That is, to find such an unanticipated signal, an output signal needs to be sampled with a sampling rate of a cycle shorter than that of the clock signal and needs to be monitored continuously.

However, increasing the sampling rate requires increasing storage capacity for holding data such as a test pattern and a collected data, but it cannot be increased thoughtlessly. If lowering the operation by lowering the rate of the operation clock in accordance with the sampling rate, the test time becomes longer.

Japanese Laid-Open Patent Application JP-P2002-108642A discloses a technique of a semiconductor integrated circuit performing processing on input data. The semiconductor integrated circuit has an internal circuit, a selection circuit, and a timing control circuit. The internal circuit uses an operation clock to operate at a speed higher than an output unit. The selection circuit selects at least one of a plurality of path signals of the internal circuit, and latches only once every N-times of operation clocks. The timing control circuit is activated in response to an activating signal and determines at what time of the N-times of operation clocks latching is performed. Moreover, the timing control circuit divides the operation clock into N-divided frequency and generates a frequency-dividing clock for shifting the phase every given period, and the selection circuit selects at least one of the plurality of path signals of the internal circuit and may latch with the frequency-dividing clock. In this manner, an internal signal can be taken out continuously at low speed.

However, in a case where such an error detection circuit and such an error correction circuit are directly applied to an inspection of an error detection output, an inspection rate of the error detection output is 1/N of an internal operation, and thus test time becomes N-times. Moreover, in a case where it is applied to an inspection of the error detection circuit, by handling the error detection output in the same manner as data output, the inspection rate becomes 1/N of the internal operation, and thus the test time and a test pattern enormously increase.

### SUMMARY OF THE INVENTION

An object of the present invention is to provide a data processing apparatus capable of reliably informing error occurrence without increasing the number of output terminals and test patterns and a test time.

According to an aspect of the present invention, a data processing apparatus includes: a memory; an error detection circuit; a timing adjustment circuit; and a terminal. The error detection circuit detects an error based on an output of the memory to output an error detection signal. The timing adjustment circuit enlarges a pulse width of a pulse signal which is generated at first after a start of a predetermined operation among pulse signals included in the error detection signal. The terminal outputs an output of the timing adjustment circuit when a test for the memory is performed.

According to another aspect of the present invention, an error detection pulse output method includes: detecting an error based on an output of a memory to output an error detection signal; enlarging a pulse width of a pulse signal which is generated at first after a start of a predetermined operation among pulse signals included in the error detection signal by a timing adjustment circuit; and outputting an output of the timing adjustment circuit when a test for the memory is performed.

According to further another aspect of the present invention, a data processing apparatus includes: an error detection circuit; a test data memory; a selection circuit; and a timing adjustment circuit. The error detection circuit detects an error of a data based on the data read from a memory to output an error detection signal. The test data memory stores a test data for an inspection of an operation of the error detection circuit. The selection circuit selects and output one of the data read from the memory and the test data read from the test data memory. The timing adjustment circuit enlarges a pulse width of a first pulse signal which is generated at first after a start of a predetermined operation among pulse signals included in the error detection signal.

According to the present invention, a data processing apparatus is provided which is capable of reliably informing error occurrence without increasing the number of output terminals and test patterns and test time.

### BRIEF DESCRIPTION OF THE DRAWINGS

The above and other objects, advantages and features of the present invention will be more apparent from the following description of certain preferred exemplary embodiments taken in conjunction with the accompanying drawings, in which:

FIG. 1 is a block diagram showing a configuration of a data processing apparatus according to a first embodiment of the present invention;

FIG. 2 is a block diagram showing a configuration of a timing adjustment circuit;

FIG. 3 is a timing diagram showing an operation of a timing adjustment circuit;

FIG. 4 is a block diagram showing another configuration of a timing adjustment circuit;

FIG. 5 is a block diagram showing another configuration of a timing adjustment circuit; and

FIG. 6 is a block diagram showing a configuration of a data processing apparatus according to a second embodiment of the present invention.

### DESCRIPTION OF THE PREFERRED EMBODIMENTS

Hereinafter, embodiments of the present invention will be described below with reference to the attached drawings.

### First Embodiment

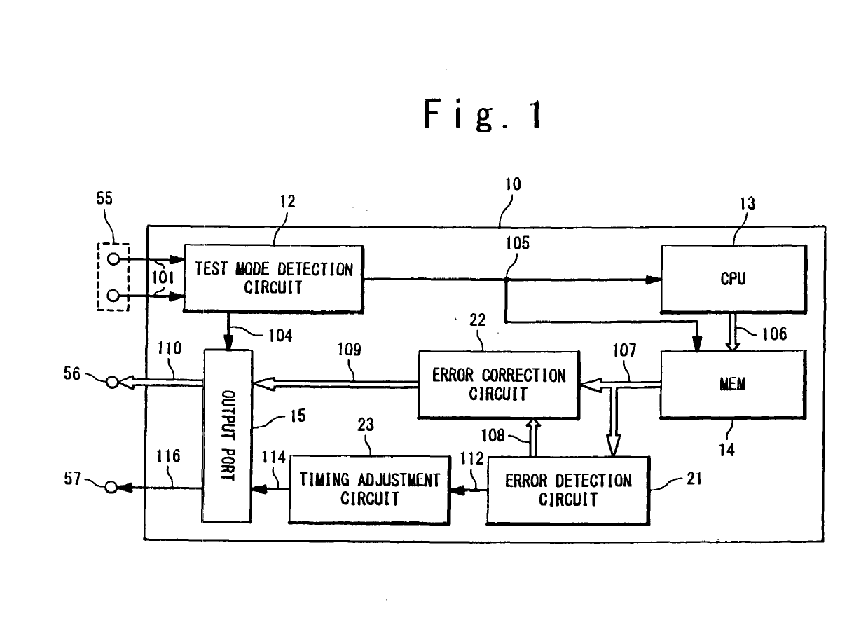

FIG. 1 shows a configuration of a data processing apparatus according to a first embodiment the present invention. The data processing apparatus 10 is a so-called microcomputer including a controller 13 equipped with a CPU (Central Processing Unit) and a memory 14 storing a program to be executed by the CPU. The data processing apparatus 10 further includes: a test mode detection circuit 12, an error detection circuit 21, an error correction circuit 22, a timing adjustment circuit 23, and an output port 15.

The controller 13 outputs an address signal 106 to the memory 14 to execute a program stored in the memory 14. In a test mode in which a reading test of the memory 14 is performed, the controller 13 outputs the address signal 106 indicating the address of the memory 14 storing a test pattern.

The memory 14 stores data (program) itself and redundant information of the data. The data stored in the memory 14 is classified into a program executed by the CPU 13, data used at the execution, the test pattern for a memory test, etc.

The test mode detection circuit 12 detects and sets a test mode based on a test mode signal 101 inputted from test mode setting terminals 55. The test mode setting is performed by the test mode detection circuit 12 by detection of, for example, a combination of states of the test mode setting terminals 55 or high voltage application. The test mode detection circuit 12 controls the test operation by supplying a test mode control signal 105 to the controller 13 and the memory 14 and an output port control signal to the output port 15. Typically in a microcomputer, a specific test mode is set and an inspection of contents of the program memory and an inspection of operations of the error detection circuit and the error correction circuit are performed.

The error detection circuit 21 detects an error based on memory output data 107 including the redundant information read from the memory 14 and outputs the detection data 108 to the error correction circuit 22. Moreover, the error detection circuit 21, upon the error detection, outputs an error detection signal 112 to the timing adjustment circuit 23.

The error correction circuit 22 corrects the error based on the memory output data 107 and the detection data 108 and outputs corrected output data 109. Typically, the controller 13 inputs the output data 109 indicating a program from the memory 14 and executes it. FIG. 1 shows connections in the test mode, where the output data 109 is outputted as output data 110 to a data output terminal 56 via the output port 15.

The timing adjustment circuit 23 outputs an error detection signal 114 whose timing has been adjusted based on the error detection signal 112 outputted from the error detection circuit 21. The error detection signal 114 is outputted as an error detection output signal 116 to an error detection output terminal 57 via the output port 15.

The output port 15 controls a signal output based on the output port control signal 104 outputted from the test mode detection circuit 12. Here, the output data 109 and the error detection signal 114 indicating test results are outputted as the output data 110 and the error detection output signal 116 to the data output terminal 56 and the error detection output terminal 57. Therefore, when the memory test has been completed, the data output terminal 56 and the error detection output terminal 57 may serve as terminals that input and output another signals.

Here, the memory 14 is described as a ROM (Read Only Memory) that is designated for reading only, but it may be a rewritable flash memory or a RAM (Random Access Memory). In these cases, when the data is written into the memory 14, the redundant information is also written simultaneously. Therefore, the data processing apparatus also includes an error correction code generation circuit that generates this redundant information.

Test data of the error detection circuit and the error correction circuit is previously written into the memory 14 together with a microcomputer controlling program to be used by a user. The error detection circuit 21, the error correction circuit 22, and the timing adjustment circuit 23 may be inspected separately from each other, but as a delay test considering connections with precedent and subsequent stages of the circuits, the test data is read from the memory 14 for the inspection.

In a case where the test mode has been set, the controller 13 and the memory 14 operate in response to the test mode control signal 105 outputted from the test mode detection circuit 12. Based on the address signal 106 outputted from the controller 13, the data indicating a program is read from the memory 14 and outputted from the data output terminal 56 and the error detection output terminal 57 to outside via the error detection circuit 21, the error correction circuit 22, the timing adjustment circuit 23, and the output port 15. By these operations, the inspection of the contents of the memory 14 and the inspection of the operation of the error detection circuit and the error correction circuit are performed.

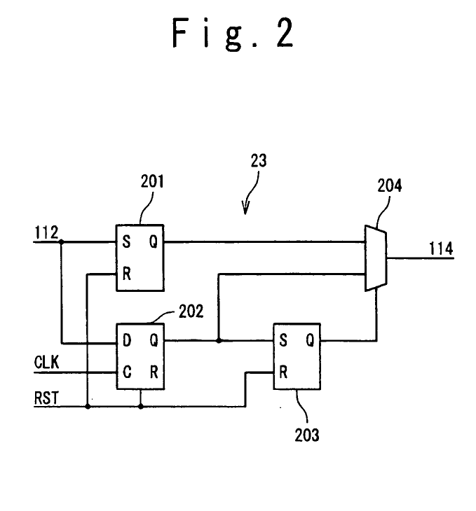

FIG. 2 shows a configuration of the timing adjustment circuit 23. The timing adjustment circuit 23 includes: RS latches 201 and 203, a delay circuit (flip-flop) 202, and a selector 204. The RS latch 201 holds that the error detection signal 112 has indicated a first error detection after start of a test (after reset release indicated by a reset signal RST). The flip-flop 202 samples the error detection signal 112 based on a clock signal CLK and outputs it with delay. The RS latch 203 outputs a selection signal for controlling the selector 204 based on the output of the flip-flop 202. The selector 204 inputs an output signal of the RS latch 201 and an output signal of the flip-flop 202. The selector 204 selects one of the signals inputted based on the selection signal outputted from the RS latch 203, and outputs it as the error detection signal 114.

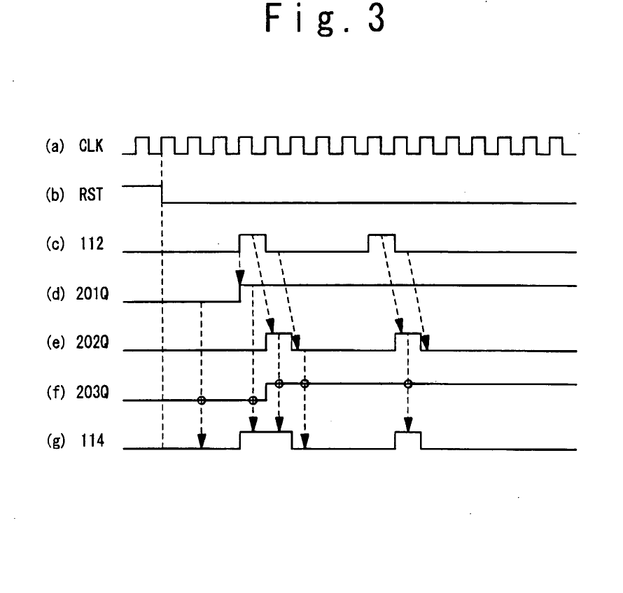

Referring to FIG. 3, an operation of the timing adjustment circuit 23 will be described below. To the timing adjustment circuit 23, the clock signal CLK (line (a) in FIG. 3) as a basis of clock operation is supplied. Before the operation starts, by the reset signal RST, the RS latches 201 and 203 and the flip-flop 202 are reset (line (b) in FIG. 3). Therefore, the output signal 201Q of the RS latch 201, the output signal 202Q of the flip-flop 202, and the output signal 203Q of the RS latch 203 are at the Low level (lines (d), (e) and (f) in FIG. 3). Upon start of normal operation or test operation, the rest signal RST is released (line (b) in FIG. 3).

When the error detection circuit 21 has detected an error in the memory output data 107, the error detection signal 112 turns to the High level (line (c) in FIG. 3). The RS latch 201, in response to the High level of the error detection signal 112, turns the output signal 201Q to the High level (line (d) in FIG. 3). Moreover, the flip-flop 202 samples the High level of the error detection signal 112 in synchronization with the clock signal CLK and outputs it with a delay of one clock (line (e) in FIG. 3).

The RS latch 203, after the resetting, outputs the Low level so that the selector 204 selects and outputs the output of the RS latch 201. Upon output of the High level by the flip-flop 202 following the first error detection, the RS latch 203 outputs the High level so that the selector 204 selects the output of the flip-flop 202 (line (f) in FIG. 3).

The selector 204, until the flip-flop 202 outputs the High level corresponding to the first error detection indicated by the error detection signal 112, selects and outputs the output signal 201Q of the RS latch 201, and then selects and outputs the output signal 202Q of the flip-flop 202. Therefore the error detection signal 114 as the output of the selector 204 turns to the High level at a rising edge of the error detection signal 112 and keeps its High level until a falling edge of the output signal 202Q of the flip-flop 202 (line (g) in FIG. 3). That is, the width of the first pulse of the error detection signal 112 is enlarged to a degree corresponding to the delay by the flip-flop 202.

When a next error is detected, the selector 204 selects and outputs the output signal 202Q of the flip-flop 202, and thus the pulse width turns to a width obtained by normalizing the error detection 25 signal 112 by the clock signal CLK (line (g) in FIG. 3). That is., the error detection signal 114 is outputted whose pulse width is almost fixed but which is delayed by the flip-flop 202.

As described above, it is possible that a plurality of clocks are outputted for the first error detection output only, and error detection result of a normal state is outputted thereafter. Specifically, the data processing apparatus 10 according to the present embodiment includes: a path passing through the RS latch 201 that directly outputs the error detection result, a path passing through the flip-flop 202 that delays the error detection result, and the circuits (the RS latch 203 and the selector 204) that switch the signals transmitted through these two paths at appropriate timing. Thus, an output pulse of the first error detection becomes an output path having a length of more than two clocks. Therefore, an enough pulse width can be ensured for a reliable error detection performed by a testing device. Further, since the pulse width extension is valid only at the first error detection and thereafter the error detection output signal 116 is outputted in a normal pulse width (pulse width outputted from the error detection circuit 21), the testing device can detect each of errors even when they are continuous. Moreover, the test can be performed at a speed of the normal operation, and thus there is no increase in test time and the test pattern.

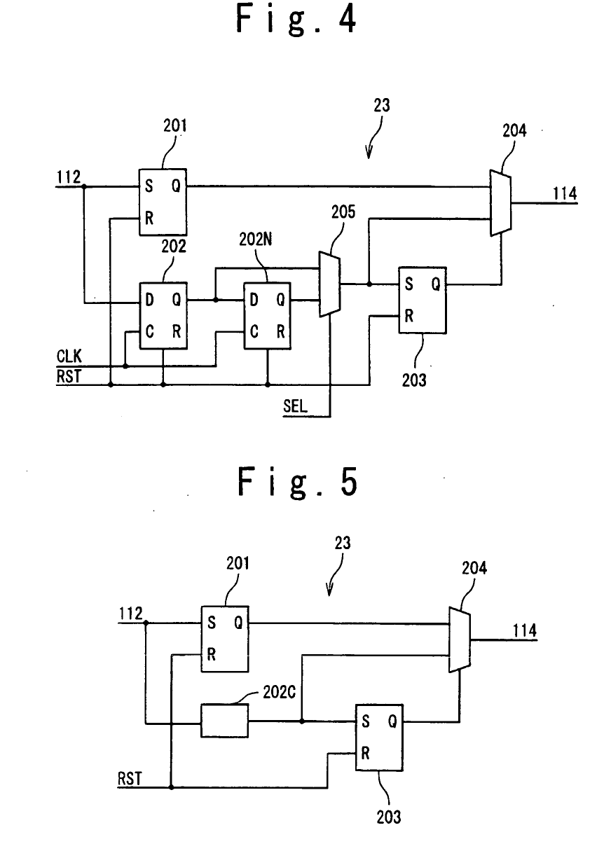

The timing adjustment circuit 23, as shown in FIG. 4, by increasing the number of stages of the flip-flops for delaying the signal as the flip-flops 202, 202N, can further elongate the pulse width of the first detected error. Moreover, any pulse width can be set by providing a selector 205 and selecting a delayed signal based on a selection signal SEL.

Moreover, as shown in FIG. 5, the timing adjustment circuit 23 can use, instead of the flip-flop 202, an analog delay circuit 202C that does not use a clock signal. In this case, the pulse width of the first error detection corresponds to a time obtained by adding together the pulse width of the error detection signal 112 and the delay time generated by the analog delay circuit 202C.

As described above, by adjusting the output pulse width of the first error detection output signal in accordance with the test device for detection, the signal can be reliably detected. The timing adjustment circuit 23 is not limited to the type having the above circuit configuration. Thus, various other types of the timing adjustment circuit 23, for example, a type that counts a pulse of the clock signal and a type that uses time of charge and discharge to and from capacitance, can be adopted.

As described above, according to the present invention, at a shipping inspection, the inspection can be performed on, including output timing, whether or not an error detection can be performed for each address, and at a fault inspection, an error detection signal irregularly outputted can be reliably extracted even by sampling whose cycle is longer than that of the clock signal.

### Second Embodiment

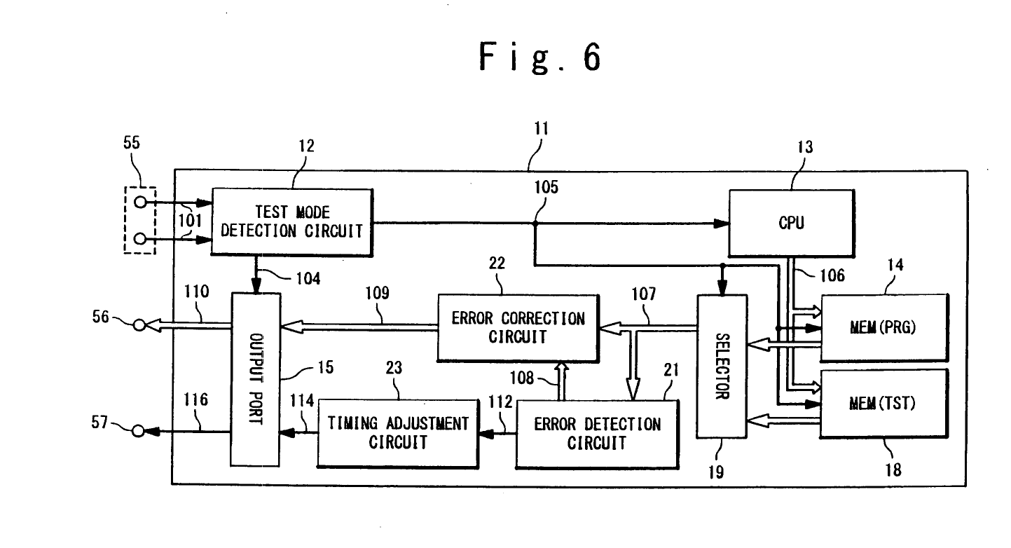

FIG. 6 is a block diagram showing configuration of a data processing apparatus according to a second embodiment. The data processing apparatus 11 according to the second embodiment is a so-called microcomputer like the data processing apparatus 10 described in the first embodiment. The data processing apparatus 11, compared to the data processing apparatus 10, further includes: a memory 18 storing test data for testing the error detection circuit and the error correction circuit; and a selector 19 that switches the test data outputted from the memory 18 and a program (data) outputted from the memory 14. In the second embodiment, the test data for testing the error detection circuit 21 and the error correction circuit 22 is stored in the dedicated memory 18. The memory 18 is preferably a ROM, but may be a rewritable memory like a flash memory or a RAM. Since the test data is not used at normal operation but used at an inspection of the error detection circuit 21 and the error correction circuit 22 and it does not have to be rewritten during the inspection, a non-rewritable ROM can be used in many cases.

During testing of the error detection circuit and the error correction circuit and a timing adjustment circuit 23, a test mode in which reading from the memory 18 for the test data is performed is first set. The test mode detection circuit 12 detects, for example, a combination of states of test mode setting terminals 55 or high voltage application, to set the test mode. When the test mode in which the reading from the memory 18 for the test data is performed has been set, the selector 19, a controller 13, and the memory 18 are operated by a test mode control signal 105 outputted from the test mode detection circuit 12. Based on an address signal 106 outputted from the controller 13, the test data is read from the memory 18 and outputted from a data output terminal 56 and an error detection output terminal 57 to outside via the error detection circuit 21, the error correction circuit 22, the timing adjustment circuit 23, and the output port 15, and the inspection of the error detection circuit and the error correction circuit is performed. An increase in test time in a case where the timing adjustment circuit 23 of the present invention is used applies to a delay time of a delay circuit 202 only and the test can be performed in short time.

At a fault inspection of the memory 14, the test mode in which the reading from the memory 14 is performed is set. The test mode detection circuit 12 detects, for example, a combination of states of the test mode setting terminals 55 or high voltage application, to set the test mode. When the test mode in which the reading from the memory 14 is performed has been set, the selector 19, the controller 13, and the memory 14 are operated by the test mode control signal 105 outputted from the test mode detection circuit 12. Based on the address signal 106 outputted from the controller 13, data is read from the memory 14 and outputted from the data output terminal 56 and the error detection output terminal 57 to the outside via the error detection circuit 21, the error correction circuit 22, the timing adjustment circuit 23, and the output port 15, and the inspection of the memory 14 is performed. At the test of the memory 14, the test is performed while considering as an expected value no error present in a memory reading result, and thus the testing device can reliably detect a fault in the memory 14 by extending the pulse width of the error detection output terminal 57.

By providing the timing adjustment circuit 23 in an error detection transmission path, an output width can be extended for only the first error detection output. As a result, even in a case of an external device that operates asynchronously, reliable error detection can be performed. Moreover, with a test of detecting an error from erroneous input data as a test of the error detection circuit, prevention of an increase in the test pattern and the test time can be achieved without switching the circuits or a test mode.

If the rate of the operation clock is set to be 1/N in accordance with the testing device, the test time becomes N-times. But an increase in the test time in a case where the circuits of the present invention are used applies to the delay time of the delay circuit 202 only and the test can be performed in short time.

Since the test operation can be performed at the same speed as that of normal operation, an error near a border between a normal operation and an abnormal operation becomes obvious, thereby easing the detection. Moreover, since the pulse width of the first error broadens, a clock of sampling for investigating present/absence of an error can be made lower than the operation clock, thus permitting testing without improving the performance of the tester.

According to the present invention, a data processing apparatus can be provided which can, based on the error detection signal indicating the first detected error, adjust the testing device and can shorten the test time and reduce a storage capacity the testing device. An error detected thereafter is indicated by an error detection signal having a pulse width outputted from the error detection circuit and the error correction circuit. Thus, even errors occurring in memory at continuous addresses can be discriminated, and thus no special processing needs to be added at time of the shipping inspection.

What is claimed is:

1. A data processing apparatus comprising:
a memory;
an error detection circuit configured to detect an error based on an output of the memory to output an error detection signal;
a timing adjustment circuit configured to enlarge a pulse width of a pulse signal which is generated at first after a start of a predetermined operation among pulse signals included in the error detection signal; and
a terminal configured to output an output the timing adjustment circuit when a test for the memory is performed.

2. The data processing apparatus according to claim 1, wherein the timing adjustment circuit comprises a flip-flop configured to input the error detection signal in synchronization with a predetermined clock signal.

3. The data processing apparatus according to claim 1, wherein the timing adjustment circuit comprises an analog delay circuit configured to output the error detection signal by delaying a timing of an output of the error detection signal with a predetermined delay time.

4. The data processing apparatus according to claim 1, further comprises:
an error correction circuit configured to an error based on an output of the memory when the error detection circuit has detected the error based on the output of the memory.

5. The data processing apparatus according to claim 1, wherein the timing adjustment circuit comprises a selection circuit configured to select the pulse width enlarged by the timing adjustment circuit.

6. An error detection pulse output method comprising:
detecting an error based on an output of a memory to output an error detection signal;
enlarging a pulse width of a pulse signal which is generated at first after a start of a predetermined operation among pulse signals included in the error detection signal by a timing adjustment circuit; and
outputting an output of the timing adjustment circuit when a test for the memory is performed.

7. The error detection pulse output method according to claim 6, wherein the enlarged pulse width is an integral multiple of a period of a predetermined clock signal.

8. The error detection pulse output method according to claim 7, further comprising:
a step of inspecting a detection of the error by sampling a pulse signal outputted from the timing adjustment circuit at a period longer than the predetermined clock signal.

9. A data processing apparatus comprising:
an error detection circuit configured to detect an error of a data based on the data read from a memory to output an error detection signal;
a test data memory configured to store a test data for an inspection of an operation of the error detection circuit;
a selection circuit configured to select and output one of the data read from the memory and the test data read from the test data memory; and
a timing adjustment circuit configured to enlarge a pulse width of a first pulse signal which is generated at first after a start of a predetermined operation among pulse signals included in the error detection signal.

10. The data processing apparatus according to claim 9, further comprising:
a test mode setting terminal configured to indicate any of a plurality of test operations, and
the timing adjustment circuit is configured to enlarge the pulse width of the first pulse signal when a predetermined test mode is set based on a signal inputted from the test mode setting terminal.
